(19) United States
(12) Patent Application Publication
(10) Pub. No.: US 2026/0221828 A1
(43) Pub. Date: Jul. 30, 2026

(54) ELECTRIC MACHINE

(71) Applicant: SAFRAN ELECTRICAL & POWER UK LTD, Pitstone Buckinghamshire (GB)

(72) Inventors: Paul David FLOWER, Pitstone Buckinghamshire (GB); Philip INDGE, Pitstone Buckinghamshire (GB); Siham Sabrina AYAT, Pitstone Buckinghamshire (GB)

(21) Appl. No.: 19/158,208

(22) PCT Filed: Feb. 20, 2024
(86) PCT No.: PCT/GB2024/050470

§ 371 Date: Aug. 20, 2025

(30) Foreign Application Priority Data
Feb. 21, 2023 (GB) 2302425.0

(51) Int. Cl. H02K 3/24; F28D 15/04; H02K 3/14; H02K 3/22

(52) U.S. Cl. CPC H02K 3/24; H02K 3/14; H02K 3/22; F28D 15/046

(57) ABSTRACT

An electric machine which includes an electrical winding. The electrical winding includes a heat pipe. A heat pipe is a device that relies on a liquid-gas phase transition to transfer heat from a first region of the pipe towards a second region of the pipe. Heat pipes work by using a sealed chamber containing a working fluid. A heat pipe is configured such that the pressure of the working fluid is set so that the working fluid will boil at a first, hotter region of the heat pipe and condense at a second, colder region of the heat pipe.

### TECHNICAL FIELD

The invention relates to an electric machine for use in an aircraft engine. In particular, the invention relates to an electric machine comprising a heat pipe for transferring heat in the electric machine.

### BACKGROUND OF THE INVENTION

Electric machines can be used for electrical power generation or to provide motive power in aircraft. An electric machine is typically formed of an assembly of magnetic circuit components comprising a stator, and a rotor configured to rotate within a bore of the stator. As is well known, rotation of the rotor relative to the stator causes interaction of the magnetic field generated by the rotor with windings provided on the stator, generating an induced electromotive force (EMF) and/or electrical current. In a permanent magnet generator, the rotor's magnetic field is produced by permanent magnets, which induces an AC voltage in the stator windings as the stator windings pass through the moving magnetic field of the permanent magnet. In a motor, a rotating AC current supplied to the windings of a stator can induce torque in a rotor.

The power capacity of electric machines for high power applications is typically thermally limited because the torque is proportional to current, and the maximum current is limited by the maximum acceptable temperature of the winding insulation. Stators are typically not isothermal and it is the temperature of the hottest point that determines peak performance.

There exists a need for improved thermal management in electric machines.

### SUMMARY OF THE INVENTION

According to an aspect of the present invention, there is provided an electric machine which comprises an electrical winding, the electrical winding comprising a heat pipe.

An electrical winding is a part of the electric machine configured to carry electrical current to generate a magnetic field, or to interact with a moving magnetic field to generate electrical power. The electrical winding may be received in a slot of a stator core or a rotor core of the electric machine. A heat pipe is a device that relies on a liquid-gas phase transition to transfer heat from a first region of the pipe towards a second region of the pipe. Heat pipes work by using a sealed chamber containing a working fluid. A heat pipe is configured such that the pressure of the working fluid is set so that the working fluid will boil (i.e. transition to a gaseous phase) at a first, hotter region of the heat pipe and condense (i.e. transition to a liquid phase) at a second, colder region of the heat pipe. Thus, thermal energy can be carried as latent heat by the gaseous or vapour phase of the working fluid. A wick can be used to aid the transfer the working fluid in its liquid phase back to the hotter region of the heat pipe. A heat pipe, which relies on a phase change between liquid and gas, provides a device having excellent thermal conductivity and requires no external device, such as a pump, for causing cooling fluid to flow in a cooling circuit.

This aspect is advantageous because it incorporates a heat transfer device within the electrically conductive part of an electric machine. Therefore, the heat pipe can provide a dual function of providing the electrical conductor to carry current in the electric machine, and facilitating the transfer of heat along the electrical winding so as to distribute heat between different regions of the electric machine.

Furthermore, this aspect addresses the problems of previous solutions. For example, flooding the stator with oil that is pumped through the small gaps in the machine can provide adequate cooling, but at the cost of increasing the complexity and weight of the machine. The invention described herein can reduce or eliminate the need for a stator cooling circuit.

The additional thermal conductivity provided by the heat pipe is present in direct contact with the conductor in the zone of highest losses within the winding, where it is most advantageous. This is particularly difficult with electric machines, since coolant must normally be isolated from the conductor with some form of insulation to prevent short circuits. Since the heat pipe is present within an individual conductor, there is no risk of short circuit.

Additionally, there is little or no loss of electrical performance by including the heat pipe because, due to the skin effects for high frequency applications, the volume occupied by the working fluid and the wick is one that would in any case carry little or none of the electrical current moving in the conductor. Such regions can therefore be formed with reduced conductivity without having a significant negative impact on the electrical performance of the conductor, especially in an alternating current or high-frequency application. Also, because a heat pipe is a sealed system, it requires no maintenance and there are no moving parts.

The electrical winding may be additively manufactured and, as such, may have a microstructure indicative of having been additively manufactured. As used herein, additive manufacturing refers to any process in which a three-dimensional object is formed one area or layer at a time by addition of material to the object. Example processes include: vat polymerisation; material jetting; binder jetting; material extrusion processes such as fused filament fabrication; sheet lamination processes such as ultrasonic additive manufacturing and laminated object manufacturing; directed energy deposition three-dimensional printing processes such as laser engineered net shaping; and powder bed fusion processes, such as direct metal laser sintering, electron beam melting, selective heat sintering, selective laser melting and selective laser sintering.

In a preferable arrangement, additive manufacture may involve depositing particles, and sintering deposited particles, for example by using an energy beam. Example energy beams include an electron beam or electromagnetic radiation, such as a laser beam, which is used to sinter or melt a powder material. A three-dimensional winding may be formed, from a digital model or another electronic data source, through additive processes in which successive layers or regions of material are laid down and subsequently solidified. A laser beam or electron beam may be used to fuse a previously-levelled powder surface layer into a thin sheet of solid material. A further layer of powder may be applied on top of the previously-fused thin sheet and the process may be repeated until a three-dimensional object is built layer-by-layer. This may be referred to as powder bed fusion (PBF), laser selective melting, or direct laser metal sintering. The additive manufacture process may be carried out in a chamber filled with an inert gas to prevent unwanted chemical reactions or the oxidation of molten metal.

An electrical conductor of the electrical winding may at least partly define a cavity of the heat pipe. The cavity may be configured to contain a working fluid of the heat pipe. A wick of the heat pipe may have a lower electrical conductivity than the electrical conductor. The wick and the electrical conductor may comprise the same chemical composition. The wick and the electrical conductor may each comprise a plurality of particles. The particles comprising the electrical conductor may be sintered completely, or at least sintered to a greater degree than the particles comprising the wick, so that the wick can have a greater porosity than the electrical conductor.

At least a portion of the electrical conductor may comprise at least two zones of higher electrical conductivity and may comprise at least one zone of lower electrical conductivity, which may be arranged to provide a Litz wire arrangement. The zone of lower electrical conductivity may be an electrical insulator, such as a vacuum, and may comprise an electrically conductive material having a plurality of discontinuities in the electrically conductive material to provide the zone of lower electrical conductivity with a lower electrical conductivity than the zones of higher electrical conductivity. The zone of lower electrical conductivity may be disposed between at least two zones of higher electrical conductivity, so as to at least partly separate the at least two zones of higher electrical conductivity along a lengthwise direction of the conductor. This aspect has the advantage of reducing energy losses due to eddy currents and skin effects, without significantly inhibiting current flow in a lengthwise direction of the conductor. Specifically, zones of higher electrical conductivity permit current flow without restriction along a lengthwise direction of the conductor, while zones of lower electrical conductivity restrict current flow in a lateral direction of the conductor. This directional conductivity can reduce eddy currents and associated energy losses.

The conductive material of the zone of lower electrical conductivity may have substantially the same chemical composition as the material of the zones of higher electrical conductivity. This has the advantage of providing a conductor that is simple and cheap to manufacture. The at least one zone of lower electrical conductivity and/or the zones of higher electrical conductivity may comprise copper, aluminium, and/or various alloys such as a copper-silver (CuAg) alloy.

The zone of lower electrical conductivity may comprise a plurality of particles. The discontinuities may be voids or pores between the particles. The discontinuities may be cracks or microcracks at points where particles are closest or touch, i.e. at junctions between particles, and/or discontinuities may be voids between particles. The zones of higher electrical conductivity may comprise a plurality of sintered particles. The zone of lower electrical conductivity may be more porous than the zones of higher electrical conductivity. The discontinuities may comprise voids, gaps, cracks or micro-cracks.

The zone or zones of lower electrical conductivity may be arranged so as to reduce eddy currents within the conductor. The zones of higher and lower electrical conductivity are preferably arranged so as to inhibit lateral current flow within the conductor. The zones of higher and lower electrical conductivity are preferably arranged so as to permit longitudinal current flow within the conductor. The zone or zones of lower electrical conductivity are preferably arranged so as to mimic insulative layers between conductors in a Litz conductor arrangement. This may be, for example, by being arranged in a sinusoidal, or helical arrangement. This may be in a braided, plaited or woven arrangement.

The plurality of regions of high conductivity may comprise at least two conductors intertwined in a helical manner. A cross-section of the portion of the electrical conductor may have a rectangular envelope. At least two conductors may be separated by the at least one region of low conductivity along at least a portion of a lengthwise direction of the electrical winding. The at least one region of low conductivity may comprise at least one channel. The at least one channel may comprise a wick of the heat pipe. A cavity of the heat pipe may be provided by a slit in the electrical conductor. The slit may be perpendicular to the at least one channel. The at least two conductors may comprise four conductors. The at least one channel may comprise four channels. Overall, this arrangement is advantageous because it provides an electrical winding having a structure that can be conveniently formed by additive manufacturing, while providing improved thermal conductivity along a slot of a ferromagnetic core and reduced eddy current losses.

According to another aspect of the invention, there is provided an electric machine for an aircraft engine, the electric machine comprising an electrical winding, the electrical winding comprising an electrical conductor at least partially received in a slot of a ferromagnetic core, wherein the electrical conductor comprises a heat pipe configured to transfer heat along the slot from a first point in the slot towards a second point outside the slot.

According to another aspect of the invention, there is provided an aircraft comprising the electric machine as described hereinabove. According to another aspect of the invention, there is provided a heat pipe for use as an electrical conductor in an electric machine.

### BRIEF DESCRIPTION OF THE DRAWINGS

Further features and advantages of the present invention will become apparent from the following description of embodiments thereof, presented by way of example only, and by reference to the drawings, in which:

FIG. 1 is a partial cross-section of an electric machine according to an embodiment;

FIG. 2 is a schematic cross-section of an electrical winding in an electric machine according to an embodiment;

FIG. 3A is a schematic cross-section of an electrical winding according to an embodiment;

FIG. 3B is a schematic cross-section of an electrical winding according to another embodiment;

FIG. 3C is a schematic cross-section of an electrical winding according to another embodiment;

FIG. 3D is a schematic cross-section of an electrical winding according to another embodiment;

FIG. 4 is a perspective view of an electrical winding according to an embodiment;

FIG. 5A is a perspective sectional view of the electrical winding of FIG. 4;

FIG. 5B is another perspective sectional view of the electrical winding of FIG. 4;

FIG. 6A is a cross-section of the electrical winding of FIG. 4;

FIG. 6B is another cross-section of the electrical winding of FIG. 4;

FIG. 6C is another cross-section of the electrical winding of FIG. 4;

FIG. 6D is another cross-section of the electrical winding of FIG. 4;

FIG. 7 is a partial cross-section of an electric machine according to an embodiment;

FIG. 8 is a schematic diagram of an aircraft according to an embodiment.

### DETAILED DESCRIPTION

An electrical winding is disclosed herein in the context of an electric machine suitable for use in an aircraft. An electric machine typically includes a stator having a plurality of magnetisable stator teeth extending from a back iron, and a rotor configured to rotate about a longitudinal axis of the stator. The stator teeth define a plurality of slots configured to receive conductors, for example in the form of conductive (e.g. copper) windings. The rotor of such an electric machine includes a plurality of magnetisable elements such as windings or permanent magnets. As such, the electric machine formed from the stator and the rotor can act as a generator when the rotor rotates relative to the stator thereby inducing an electric current in the windings of the stator, and can also act as an electric motor when an electric current provided in the windings induces rotation of the rotor.

The present disclosure seeks to provide an improved stator or rotor assembly for an electric machine, which reduces the hot-spot temperature, by making the stator more isothermal and/or by reducing the average temperature. The electric machine disclosed herein includes a core comprising a plurality of slots which receive at least one electrical winding. The electrical winding comprises an electrical conductor, such as copper, for the distribution of electric current. The electrical conductor comprises a heat pipe. In this way, the heat pipe is provided by the electrical winding of the electric machine. The heat pipe is configured to distribute heat between different parts of the core, for example between a central region and a periphery of the core.

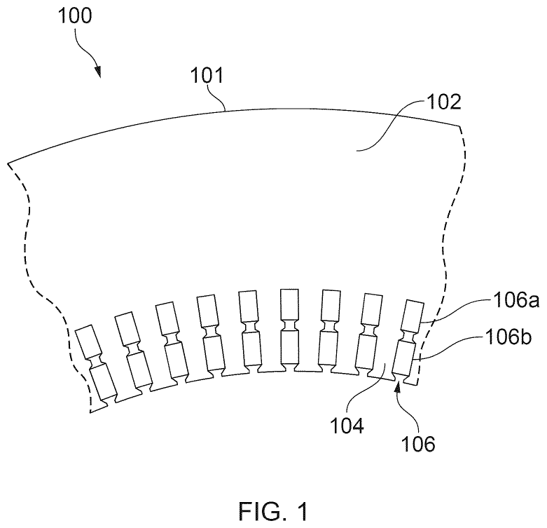

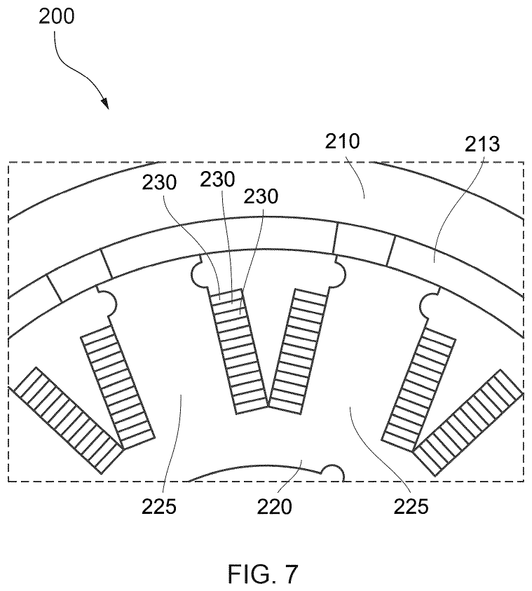

FIG. 1 illustrates part of an electric machine 100. The electric machine 100 comprises a core 101. In the arrangement shown, the core 101 is a stator core disposed around a rotor (not shown), but it will be understood that the disclosure equally applies to an arrangement in which the rotor is disposed around a stator (see FIG. 7) and the conductors comprising a heat pipe as described herein can be applied to windings of a rotor or a stator in either case. The core 101 can be a ferromagnetic core of a stator or a rotor. In the arrangement shown, the core 101 comprises a back iron 102 and a plurality of teeth 104 extending in a radial direction from the back iron 102. A plurality of slots 106 is defined between adjacent pairs of teeth 104. In the illustrated arrangement, a slot 106 comprises a first section 106a and a second section 106b, which can facilitate a double winding arrangement. The first section 106a is disposed at a radially outward position with respect to the second section 106b.

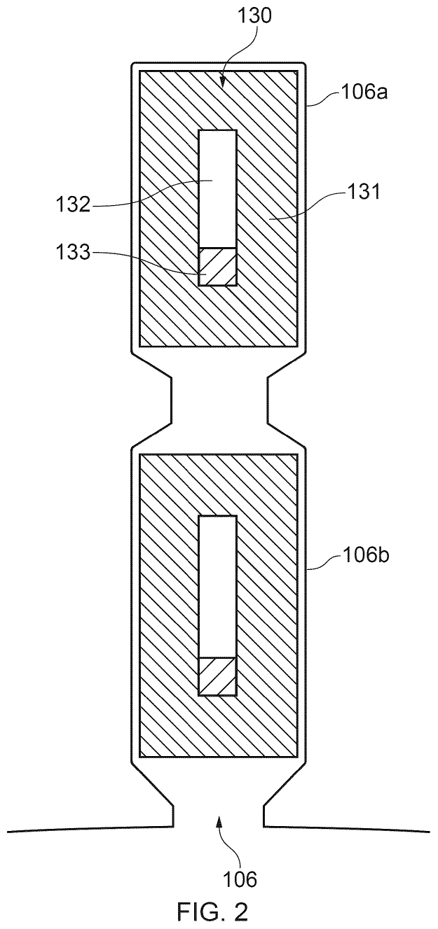

FIG. 2 illustrates a cross-section of an electrical winding 130 received by a slot 106. The electrical winding 130 comprises a conductor 131. The conductor 131 may comprise copper or another suitable electrically conducting material. The conductor 131 is configured to carry electric current through the core 101. The conductor 131 comprises a heat pipe. In the arrangement shown, the conductor 131 defines a cavity 132 configured to contain a working fluid (not shown). The working fluid may be water. The conductor 131 can be configured to fit within the slot 106 such that an outer surface of the conductor 131 is in close contact with the inner surface of the slot 106. In the arrangement shown, the conductor 131 has a rectangular cross-section corresponding to the rectangular cross-section of the slot 106. It will be appreciated that in alternative arrangements, the conductor 131 may have a different shape and may be received by a correspondingly-shaped part of a slot. A slot liner (not shown) may be provided between the inner surface of the slot 106 and the outer surface of the conductor 131. FIG. 2 shows an arrangement in which each of the first section 106a and the second section 106b comprises a conductor, but it will be appreciated that this disclosure applies equally to a single winding arrangement in which a single conductor is received in each slot 106. In some arrangements, only a proportion of the slots contain conductors having a heat pipe incorporated therein. In some arrangements, a slot may comprise multiple conductors, wherein at least one conductor comprises a heat pipe. Preferably, a slot or slot section 106b closest to the rotor may comprise a heat pipe.

The cavity 132 is configured to facilitate the transfer of working fluid along the conductor 131, so that the working fluid in its vapour phase can be transferred from one longitudinal region in the slot 106 to another longitudinal region in the slot 106. The cavity 132 extends longitudinally through at least a portion of the slot 106. In the arrangement shown, the cavity 132 has a rectangular cross-section, but it will be appreciated that the disclosure is not limited to this shape. The cavity 132 is sealed so as to contain the working fluid within the conductor 131. In the illustrated arrangement, the cavity 132 is defined by the walls of the conductor 131. The cavity 132 can be further defined by solid end portions (not shown in FIG. 2) of the conductor 131 at each longitudinal end thereof.

The conductor 131 may further comprise a wick 133. The wick 133 is configured to transfer the working fluid along the conductor 131, so that the working fluid in its liquid phase can be transferred from one longitudinal region in the slot 106 to another longitudinal region in the slot 106. As such, the wick 133 extends longitudinally along the conductor 131. The wick 133 may extend along the same longitudinal portion of the slot 106 as the cavity 132. The wick 133 is in fluid communication with the cavity 132. As such, the working fluid in its vapour phase can be transferred from a hotter region to a cooler region of the slot 106 via the cavity 132, and can be transferred in its liquid phase from the cooler region to the hotter region of the slot 106 via the wick 133.

The wick 133 can be configured to facilitate the transfer of liquid by capillary action. As such, the wick 133 may comprise any material or structure suitable for transferring liquid by capillary action along the conductor 131. The wick 133 may comprise a plurality of un-sintered or partially sintered particles to provide a porous structure. A porous structure may also be provided by forming the wick 133 from a latticed structure. In some arrangements, the conductor 131 is formed of a plurality of sintered particles (e.g. copper), which may be fully sintered particles, in order to provide a zone of relatively higher electrical conductivity, while the wick 133 is formed of a plurality of partially sintered particles (e.g. copper) in order to provide a porous zone of relatively lower electrical conductivity.

The electrical winding 130 may be formed by additive manufacturing, and may have a microstructure indicative of having been manufactured additively. Additive manufacture may involve depositing particles, and sintering or otherwise fusing together deposited particles, for example by using an energy beam. In this way, the conductor 131 and the wick 133 can be formed from the same material (e.g. copper powder) subjected to different degrees of sintering from the energy beam. The wick 133 is represented schematically in FIG. 2 as having a rectangular cross-section and being disposed at a radially inward portion of the cavity 132. However, it will be appreciated that the wick 133 may be disposed at other positions in the electrical winding 130 which are in fluid communication with the cavity 132.

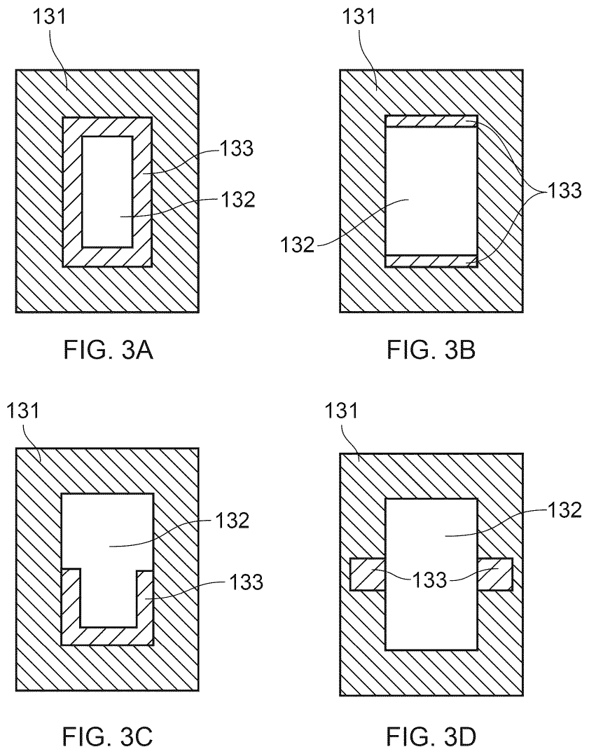

FIGS. 3A to 3D illustrate, in transverse cross-section, with a longitudinal axis of the heat pipe extending into and out of the page when looking at these figures, several arrangements of how the wick 133 may be arranged in an electrical winding 130 with respect to the conductor 131 and the cavity 132. As shown in FIG. 3A, the wick 133 may be provided on an inner surface of the conductor 131 so as to surround the cavity 132. The wick 133 may comprise two or more wicking portions which may be distributed at different positions within the cavity 132. In the arrangement shown in FIG. 3B, the wick 133 comprises two wicking portions at a radially inner and a radially outer wall of the cavity 132. As shown in FIG. 3C, the wick 133 may cover a portion of the inside wall of the cavity 132, and may be provided by a U-shaped cross-section. FIG. 3D shows an arrangement having two wicking portions, a first wicking portion on a left side of the conductor 131 and a second wicking portion on the right side of the conductor 131. These examples are not mutually exclusive, but rather could be combined with each other to form additional wicks having different arrangements. Furthermore, an arrangement shown in cross-section need not extend along the entire longitudinal extent of the cavity 132. Rather, the wick may have a first arrangement (e.g. FIG. 3A) at a first portion of the electrical winding 130 and may have a second arrangement (e.g. FIG. 3B) at a second portion of the electrical winding 130 at a different longitudinal position to the first portion. The first portion may be provided within the longitudinal extent of the core 101 (i.e., between end faces thereof), while the second portion may be provided beyond at least one of the end faces.

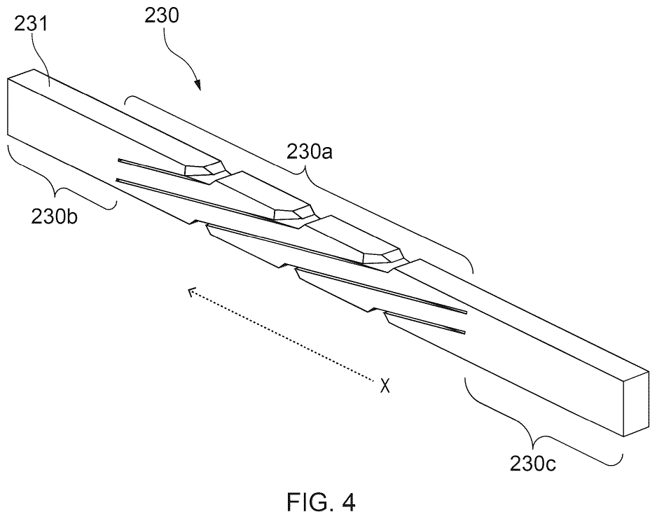

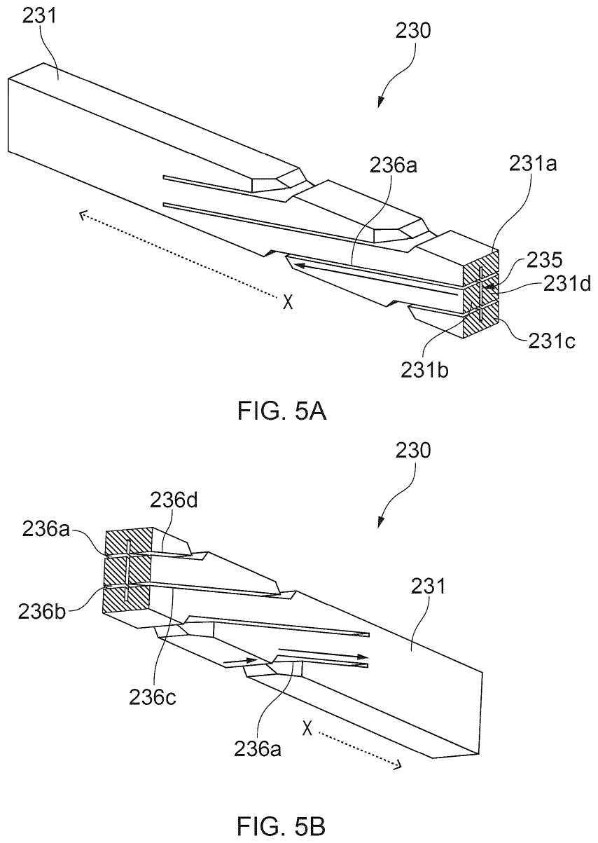

Another arrangement (not illustrated) of the electrical winding may include the cavity 132 being completely filled with a porous material. In this arrangement, working fluid in the liquid phase could be transferred by capillary action along the porous material, while working fluid in the vapour phase could be transferred via empty channels in the porous material. In other words, the cavity 132 may be at least partially filled with a lattice structure that provides both a vapour channel and a wick. Furthermore, the wick need not be a separate material to the conductor 131, but rather could be provided by surface detail on an inside surface of the conductor 131, such as by the provision of longitudinal grooves. FIG. 4 illustrates another arrangement of an electrical winding 230. The electrical winding 230 comprises a conductor 231. The electrical winding 230 may have an intermediate portion 230a disposed between two ends regions 230b, 230c. In the illustrated arrangement, the end regions 230b, 230c comprise solid bar conductors and may be configured to provide electrical connections with power electronics of the electric machine. The end regions 230b, 230c can also provide mechanical support to the intermediate portion 230a. At least one of the end regions 230b, 230c may comprise at least part of a heat pipe. In some arrangements, an end region can comprise one of the arrangements described in relation to FIGS. 3A to 3D. The cavity 132 may be in fluid communication with a passage 235 (see FIGS. 5A and 5B) of the intermediate portion 230a.

In the arrangement shown, the intermediate portion 230a comprises a heat pipe which may comprise a helical arrangement of conductors, as explained further below. In this respect, the electrical winding 230 comprises a shell (omitted for clarity) configured to contain the working fluid of the heat pipe. Similarly to the electrical winding 130 described above, the electrical winding 230 is configured to be received by a slot of a core, such as the slot 106 in the core 101 described in relation to FIG. 1. The arrow labelled ‘X’ denotes the longitudinal direction defined by a slot when the electrical winding 230 is inserted therein. The relative dimensions of the electrical winding 230 are not limited to those shown in FIG. 4. Rather, one or both of the end regions 230b, 230c may be shorter or longer than that shown in FIG. 4. Similarly, the intermediate portion 230a may be longer or shorter than that shown in FIG. 4. Furthermore, the pitch and the number of turns of the helical arrangement may differ from those shown in FIG. 4.

FIGS. 5A and 5B show a perspective sectional view of the electrical winding 230 from the top right and the bottom left, respectively. The electrical winding 230 comprises an electrical conductor 231. At least a portion of the electrical conductor 231 comprises at least one zone or region of low electrical conductivity and a plurality of zones or regions of high electrical conductivity. In other words, the electrical conductor 231 comprises at least one region having a first electrical conductivity and a plurality of regions having a second electrical conductivity, wherein the first electrical conductivity is lower than the second electrical conductivity. In this way, the electrical conductor provides a Litz wire arrangement. A Litz wire is known in the field of alternating currents and is an electrical conductor comprising a plurality of conductive paths, which are at least partially electrically insulated from one another, and which follow non-linear and non-parallel paths within the longitudinal envelope of the conductor. The paths may preferably be arranged substantially helically relative to, or about, a longitudinal axis of the conductor. The paths may be provided within and/or integrally with the heat pipe. In the present context, the regions of relatively high conductivity may provide the conductive paths. The regions of relatively low electrical conductivity may provide the areas of reduced conductivity to at least partially insulate the conductive paths from one another. The regions of relatively low electrical conductivity may comprise an electrical insulator. In the arrangement shown, the conductor 231 comprises such an arrangement in the intermediate portion 230a. The conductor 231 can have a substantially rectangular envelope, as shown in FIGS. 5A and 5B, but other shapes could be envisaged, such as circular.

The plurality of regions of high conductivity comprises at least two conductors arranged in a twisting or helical manner along a direction X. The at least one region of low conductivity can comprise at least one channel configured to separate the at least two conductors from each other. The channels may be arranged to be parallel to each other in a cross-sectional plane of the electrical winding. The at least one channel may provide an electrical insulator, such as gas, air or a vacuum. The at least one channel may comprise a material (not shown) having a lower electrical conductivity relative to the at least two conductors, such as a plurality of partially sintered particles, which may act as a wick for the working fluid of the heat pipe. Therefore, the at least one channel can be arranged to transfer the working fluid in its liquid phase and/or its vapour phase.

The electrical winding 230 can also comprise a passage 235 which may be located in a central region between the at least two conductors, in the plane normal to the longitudinal direction X. The passage 235 may provide an electrical insulator, such as a vacuum. The passage 235 can comprise a material (not shown) having a lower electrical conductivity relative to the at least two conductors, such as a plurality of partially sintered particles, which may act as a wick. Therefore, the passage 235 can be arranged to transfer the working fluid in its liquid phase and/or its vapour phase. Alternatively or additionally, the wick may be provided by a gap or gaps between conductors, for example by the passage 235 and/or the channels 236a-d.

In the illustrated arrangement, the electrical winding 230 comprises four conductors 231a, 231b, 231c, 231d. The conductors 231a-231d are arranged in a helical manner along direction X. The electrical winding 230 comprises four channels 236a-236d arranged in a corresponding helix along direction X. In FIGS. 5A and 5B, the arrows provided on the electrical winding 230 illustrate a helical path of a first channel 236a. The channels 236a-236d extend between the conductors 231a-231d in a horizontal direction, such that the channels are parallel to each other in a plane normal to the longitudinal direction X of the electrical winding 230. The channels 236a-236d comprise a wick, for example in the form of a plurality of partially sintered particles, configured to transfer the working fluid in its liquid phase. The electrical winding 230 also comprises a passage 235 which provides a void configured to transfer the working fluid in its vapour phase along the electrical winding 230. The passage 235 is provided as a slit 235 extending along the intermediate portion 230a in the direction X through the electrical winding 230. The passage 235 is perpendicular to the channels 236a-236d in the plane normal to the longitudinal direction X.

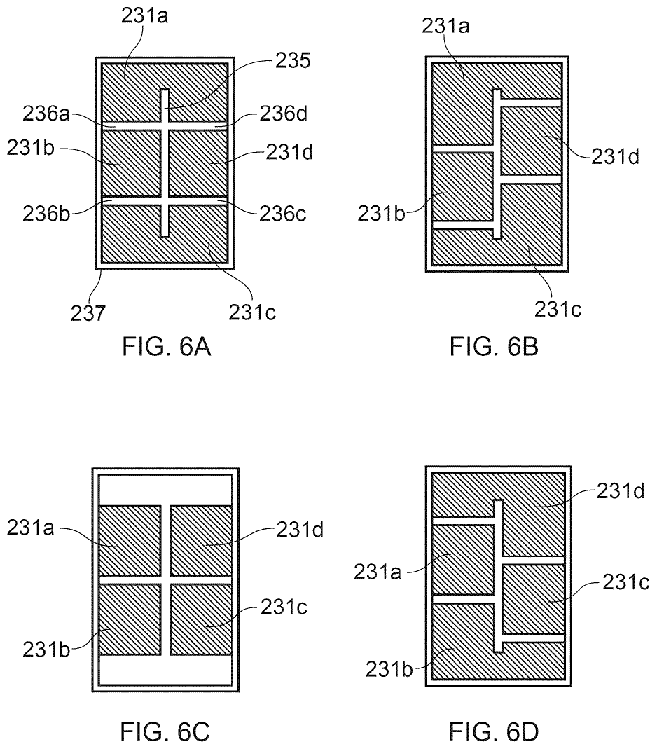

FIGS. 6A to 6D show a cross-sectional view at different points along the longitudinal direction X of the electrical winding 230. Overall, these figures show how the helical arrangement of the conductors 231a-231d can progress along the longitudinal direction X of the electrical winding 230. Also, these figures show a casing or shell 237 configured to contain the working fluid. The shell 237 provides an envelope of the heat pipe arrangement around the conductor 231. The shell 237 may comprise the same material as the conductor 231, such as copper. Along the longitudinal direction of the intermediate portion 230a, the passage 235 can be configured to stay in the same position relative to the shell 237. In contrast, the channels 236a-236d can be configured to shift relative to the envelope in a helical manner, while remaining parallel to one another. The remaining area in each cross-section can be occupied by the conductor 231, thereby forming four conductors 231a-231d separated by the passage 235 and the channels 236a-236d in the illustrated arrangement. In each cross-sectional view, the conductors 231a-231d can be arranged so as to have an order of rotational symmetry equal to at least 2.

In FIG. 6A, a first cross-section is shown in which a first conductor 231a and a third conductor 231c are U-shaped and are provided on opposite sides of the electrical winding 230, which may be a top side and a bottom side, respectively, and are inverted with respect to one another. The second conductor 231b and fourth conductor 231d are substantially rectangular and are aligned on opposite sides of the electrical winding 230, which may be a left side and a right side, respectively. A first channel 236a (which separates the first conductor 231a from the second conductor 231b) and a fourth channel 236d (which separates the fourth conductor 231d from the first conductor 231a) may be aligned in a horizontal direction, i.e., in a direction perpendicular to the slit 235. A second channel 236b (which separates the second conductor 231b from the third conductor 231c) and a third channel 236c (which separates the third conductor 231c from the fourth conductor 231d) may be aligned in the horizontal direction.

In FIG. 6B, a second cross-section is shown in which the second conductor 231b and the fourth conductor 231d are substantially rectangular and are misaligned on opposite sides of the electrical winding 230. The first conductor 231a and the third conductor 231c are J-shaped and are provided on opposite sides of the electrical winding 230, inverted with respect to one another.

In FIG. 6C, a third cross section is shown in which the conductors 231a-231d are substantially rectangular and are arranged in a square or rectangular array, such that a first half of the array is defined by the first conductor 231a and the fourth conductor 231d, and a second half of the array is defined by the second conductor 231b and the third conductor 231c.

In FIG. 6D, a fourth cross section is shown which is arranged as the mirror image of that shown in FIG. 6B. The first conductor 231a and the third conductor 231c are substantially rectangular and are misaligned on opposite sides of the electrical winding 230. The second conductor 231b and the fourth conductor 231d are J-shaped and are provided on opposite sides of the electrical winding 230, inverted with respect to one another. It will be understood that a fifth cross-section at a position further along the longitudinal direction X would have the same appearance as that of FIG. 6A, except that the positions of the conductors and channels would be shifted around with respect to the shell 237 in the anticlockwise direction.

While an electrical winding 230 having a helical arrangement in an intermediate portion 230a has been described, further arrangements of the at least two conductors can be envisaged such that the electrical winding is configured to reduce eddy currents. Instead of a helical arrangement, the at least two conductors may be braided or twisted, or otherwise intertwined around one another in any other non-linear arrangement.

FIG. 7 illustrates part of an arrangement of an electric machine 200. The electric machine 200 comprises a stator 220 having a plurality of stator teeth 225. The stator 220 is disposed radially inwards of a rotor 210. The rotor 210 has a plurality of permanent magnets 213. At least one electrical winding 230 can be received between the stator teeth 225. In the arrangement shown, a plurality of electrical windings 230 are provided as turns around a stator tooth 225. In this way, a concentrated winding arrangement can be provided wherein wound conductors comprise at least one heat pipe. While an electrical winding 230 of the type described in relation to FIG. 4 is illustrated, it will be appreciated that one or more electrical windings 130 described in relation to FIGS. 2 and 3A-3D could equally be comprised in the stator 220. Similarly, the electrical winding 230 can be received in the arrangement shown in FIGS. 1 and 2, i.e. an arrangement in which the stator 120 is disposed radially outward of a rotor.

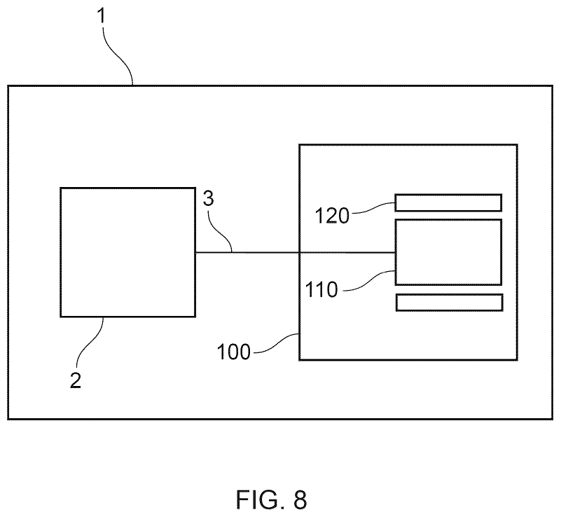

FIG. 8 is a schematic diagram illustrating an aircraft 1. The aircraft 1 comprises a driving or driven element 2 and an electric machine 100 connected to the driven element 2 by a drive shaft 3. The electric machine 100 comprises the stator 120 and the rotor 110. The rotor 110 can be connected to the drive shaft 3 and configured to rotate within the stator core 120. The electrical winding as described above may be incorporated into the stator 120 and/or the rotor 110.

With reference to any of the above-described arrangements, operation of the electrical winding in the electric machine may be as follows. When the drive shaft 3 is driven by the aircraft engine 1, the rotor 110 rotates relative to the stator 120 to thereby generate current in the electrical windings, which also generates heat. The thermal energy in one region of the electrical winding heats up the working fluid in the heat pipe until it boils into its vapour phase, thereby absorbing thermal energy. This may occur in a central region of the slot with respect to the longitudinal direction thereof. The vapour travels along the heat pipe to a cooler region where it condenses back into liquid. This may occur in proximity to an axial end face of the stator where the ends of the electrical windings are cooled by a coolant circuit. Then, the liquid travels back towards the hotter region, by capillary action and/or gravity, for the cycle to repeat.

Various modifications, whether by way of addition, deletion and/or substitution, may be made to all of the above described embodiments to provide further embodiments, any and/or all of which are intended to be encompassed by the appended claims.

1. An electric machine comprising an electrical winding, the electrical winding comprising a heat pipe;
wherein an electrical conductor of the electrical winding at least partly defines a cavity of the heat pipe, the cavity being configured to contain a working fluid of the heat pipe; and
wherein at least a portion of the electrical conductor of the electrical winding comprises at least one region of low conductivity and a plurality of regions of high conductivity arranged such that the electrical conductor provides Litz wire arrangement.

2. The electric machine according to claim 1, wherein the electrical winding is received in a slot of a stator core or a rotor core of the electric machine.

3. The electric machine according to claim 1, wherein the electrical winding has a microstructure indicative of having been additively manufactured.

4. The electric machine according to claim 1, wherein a wick of the heat pipe has a lower electrical conductivity than the electrical conductor.

5. The electric machine according to claim 4, wherein the wick and the electrical conductor comprise the same chemical composition.

6. The electric machine according to claim 4, wherein the wick and the electrical conductor each comprises a plurality of particles, wherein the particles comprising the electrical conductor are sintered to a greater degree than the particles comprising the wick, so that the wick has a greater porosity than the electrical conductor.

7. The electric machine according to claim 1, wherein the plurality of regions of high conductivity comprises at least two conductors intertwined in a helical manner.

8. The electric machine according to claim 1, wherein a cross-section of the portion of the electrical winding has a substantially rectangular envelope.

9. The electric machine according to claim 7, wherein the at least two conductors are separated by the at least one region of low conductivity, wherein the at least one region of low conductivity comprises at least one channel, the at least one channel comprising the wick of the heat pipe.

10. The electric machine according to claim 9, wherein a cavity of the heat pipe is provided by a slit in the electrical conductor, the slit being perpendicular to the at least one channel.

11. The electric machine according to claim 9, wherein the at least two conductors comprises four conductors, and the at least one channel comprises four channels.

12. An aircraft comprising the electric machine according to claim 1.

13. (canceled)
